(19) United States
(12) Patent Application Publication
(10) Pub. No.: US 2012/0127159 A1
(43) Pub. Date: May 24, 2012

(54) METHOD OF DRIVING DISPLAY PANEL AND DISPLAY APPARATUS FOR PERFORMING THE SAME

(75) Inventors: Jee-Hoon JEON, Hwaseong-si (KR); Jun-Pyo LEE, Asan-si (KR); Jae-Ho OH, Seoul (KR); Min-Kyu PARK, Cheonan-si (KR); Kang-Min KIM, Seoul (KR); Jung-Won KIM, Seoul (KR); Hyoung-Sik NAM, Incheon (KR)

(73) Assignee: SAMSUNG ELECTRONICS CO., LTD., Suwon-si (KR)

(21) Appl. No.: 13/104,083

(22) Filed: May 10, 2011

(30) Foreign Application Priority Data
Nov. 19, 2010 (KR) 2010-0115353

(51) Int. Cl. G06T 15/00

(52) U.S. Cl. 345/419

(57) ABSTRACT

A method of driving a display panel includes identifying a dimension of input data, where the input data is one of two-dimensional input data and three-dimensional input data, and generating first distributed data and second distributed data based on the dimension of the input data by at least one of copying the input data and dividing the input data into front data and back data.

This application claims priority to Korean Patent Application No. 2010-115353, filed on Nov. 19, 2010, and all the benefits accruing therefrom under 35 U.S.C. §119, the content of which in its entirety is herein incorporated by reference.

### BACKGROUND OF THE INVENTION

(1) Field of the Invention

Exemplary embodiments of the present invention relate to a method of driving a display panel and a display apparatus for performing the method. More particularly, exemplary embodiments of the present invention relate to a method of driving a display panel which processes a two-dimensional (“2D”) image and a three-dimensional (“3D”) image, and a display apparatus for performing the method.

(2) Description of the Related Art

Generally, a liquid crystal display apparatus displays a 2D image. Recently, as a demand for displaying a 3D image have been increasing in video game and movie industries, the liquid crystal display apparatus has been developed to display the 3D image.

Generally, a stereoscopic image display apparatus displays the 3D image using a binocular parallax between two eyes of human. For example, as two eyes of human are spaced apart from each other, images viewed by the two eyes at different angles are inputted to the human brain. Thus, an observer may recognize the stereoscopic image through the stereoscopic image display apparatus.

The stereoscopic image display device may include a stereoscopic type and an auto-stereoscopic type depending on wearing an extra spectacle or not. The stereoscopic type may include an anaglyph type and a shutter glass type, for example. In the anaglyph type, a viewer typically wears blue glasses and red glasses to recognize the 3D image. In the shutter glass type, a left image and a right image may be temporally divided to be periodically displayed, and a viewer wears glasses which opens and closes a left eye shutter and a right eye shutter in synchronization with the period of the left and right images.

The liquid crystal display is differently operated based on types of input data which may include 2D input data or 3D input data. A conventional data distributor includes a repeater, a frame rate converter (“FRC”) and a 3D converter.

When the input data is the 2D input data, the repeater receives the input data. The repeater copies the input data, and outputs the input data to the FRC. The FRC adjusts a frame rate of the input data, and outputs the input data to the 3D converter. The 3D converter transmits the input data to a timing controller, and a path of the input data directly transmitted from the repeater to the 3D converter may be blocked.

When the input data is the 3D input data, the repeater receives the input data. The repeater transmits the input data to the 3D converter. The 3D converter performs upscaling the input data, and outputs the upscaled input data to the timing controller and, a path of the input data transmitted from the repeater to the 3D converter via the FRC may be blocked.

As disclosed above, the conventional liquid crystal display apparatus includes independent elements that process the 2D and 3D images, respectively. Accordingly, a structure of a driving part of the conventional liquid crystal display apparatus is complex. In addition, the 2D and 3D images may be transmitted to the timing controller through the independent paths such that wirings to transmit the 2D and 3D images are complex.

### BRIEF SUMMARY OF THE INVENTION

Exemplary embodiments of the present invention provide a method of driving a display panel which processes both two-dimensional (“2D”) and three-dimensional (“3D”) images.

Exemplary embodiments of the present invention also provide a display apparatus for performing the method of driving the display panel.

In an exemplary embodiment, a method of driving a display panel includes: a dimension of input data, where input data include one of 2D input data and 3D input data; and generating first distributed data and second distributed data based on a dimension of the input data based on a dimension of the input data by at least one of copying the input data and dividing the input data into front data and back data.

In an exemplary embodiment, the method may further include outputting the first distributed data to a first frame rate converter (“FRC”) and outputting the second distributed data to a second FRC.

In an exemplary embodiment, when the input data is the three-dimensional input data and when the 3D input data includes left eye data and right eye data, the first distributed data includes front data of the left eye data and front data of the right eye data and the second distributed data includes back data of the left eye data and back data of the right eye data.

In an exemplary embodiment, a resolution of each of the left eye data and the right eye data may be 1920×1080 pixels.

In an exemplary embodiment, a frame rate of each of the left eye data and the right eye data may be 60 hertz (Hz).

In an exemplary embodiment, the method may further include outputting output data to the display panel, where the output data includes left output data generated based on the left eye data and right output data generated based on the right eye data, and where a frame rate of the output data is 240 Hz.

In an exemplary embodiment, the output data may include the left output data, black data, the right output data and the black data sequentially disposed therein.

In an exemplary embodiment, the output data may include the left output data, the left output data, the right output data and the right output data sequentially disposed therein.

In an exemplary embodiment, when the input data include the 3D input data and the input data include one of the left eye data and the right eye data, the first and second distributed data may be generated by copying the input data.

In an exemplary embodiment, the method may further include receiving the input data into receiving parts, and shutting down a portion of the receiving parts which do not receive the input data.

In an exemplary embodiment, when the input data is the three-dimensional input data and when the input data includes the left eye data and the right eye data, the first distributed data may include left eye data, and the second distributed data may include right eye data.

In an exemplary embodiment, the first distributed data and the second distributed data may be generated by copying the input data when the input data includes the two-dimensional input data.

In an exemplary embodiment, a display apparatus includes a display panel which displays an image, a data distributor which identifies a dimension of input data, and generates first distributed data and second distributed data based on the dimension of the input data by at least one of copying the input data and dividing the input data into front data and back data, wherein the input data is one of 2D input data and 3D input data, and a display panel driver which outputs a data voltage to the display panel using the first distributed data and the second distributed data.

In an exemplary embodiment, the display apparatus may further include a FRC including a first FRC which converts a frame rate of the first distributed data and a second FRC which converts a frame rate of the second distributed data.

In an exemplary embodiment, when the input data is the 3D input data and when the 3D input data includes left eye data and right eye data, the first distributed data includes front data of the left eye data and front data of the right eye data, and the second distributed data includes back data of the left eye data and back data of the right eye data.

In an exemplary embodiment, the data distributor may be disposed on a television (“TV”) set board which receives the input data from an external apparatus.

In an exemplary embodiment, the data distributor may be integrated into a TV set chip which receives the input data from an external apparatus.

In an exemplary embodiment, the data distributor may be disposed on a timing controller substrate of the display panel driver, where the timing controller may generate a control signal and grayscale data.

In an exemplary embodiment, the data distributor may be integrated into a timing controller chip of the display panel driver, where the timing controller may generate a control signal and grayscale data.

According to exemplary embodiments of the method of driving the display panel and the display apparatus for performing the method, a single data distributor may process the 2D and 3D images such that the structure of a data driver and wirings are substantially simplified.

### BRIEF DESCRIPTION OF THE DRAWINGS

The above and other features and advantages of the invention will become more apparent by describing in detailed exemplary embodiments thereof with reference to the accompanying drawings, in which:

FIG. 1 is a block diagram illustrating an exemplary embodiment of a display apparatus according to the present invention;

FIG. 2 is a block diagram illustrating an exemplary embodiment of a data distributor of FIG. 1;

FIG. 3 is a flowchart illustrating an exemplary embodiment of a method of processing input data by the data distributor of FIG. 1;

FIG. 4 is a block diagram illustrating an exemplary embodiment of a method of processing two-dimensional (“2D”) input data by the data distributor, a frame rate converter (“FRC”) and a timing controller of FIG. 1;

FIG. 5 is a block diagram illustrating an exemplary embodiment of a method of processing three-dimensional (“3D”) input data in a first mode by the data distributor, the FRC and the timing controller of FIG. 1;

FIG. 6 is a block diagram illustrating an exemplary embodiment of the method of processing 3D input data in a second mode by the data distributor, the FRC and the timing controller of FIG. 1;

FIG. 7 is a block diagram illustrating an exemplary embodiment of the method of processing 3D input data in a third mode by the data distributor, the FRC and the timing controller of FIG. 1;

FIG. 8 is a block diagram illustrating an alternative exemplary embodiment of the display apparatus according to the present invention; and

FIG. 9 is a block diagram illustrating an alternative exemplary embodiment of the display apparatus according to the present invention.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “lower,” “under,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “under” relative to other elements or features would then be oriented “above” relative to the other elements or features. Thus, the exemplary term “lower” and “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the present invention will be described in further detail with reference to the accompanying drawings.

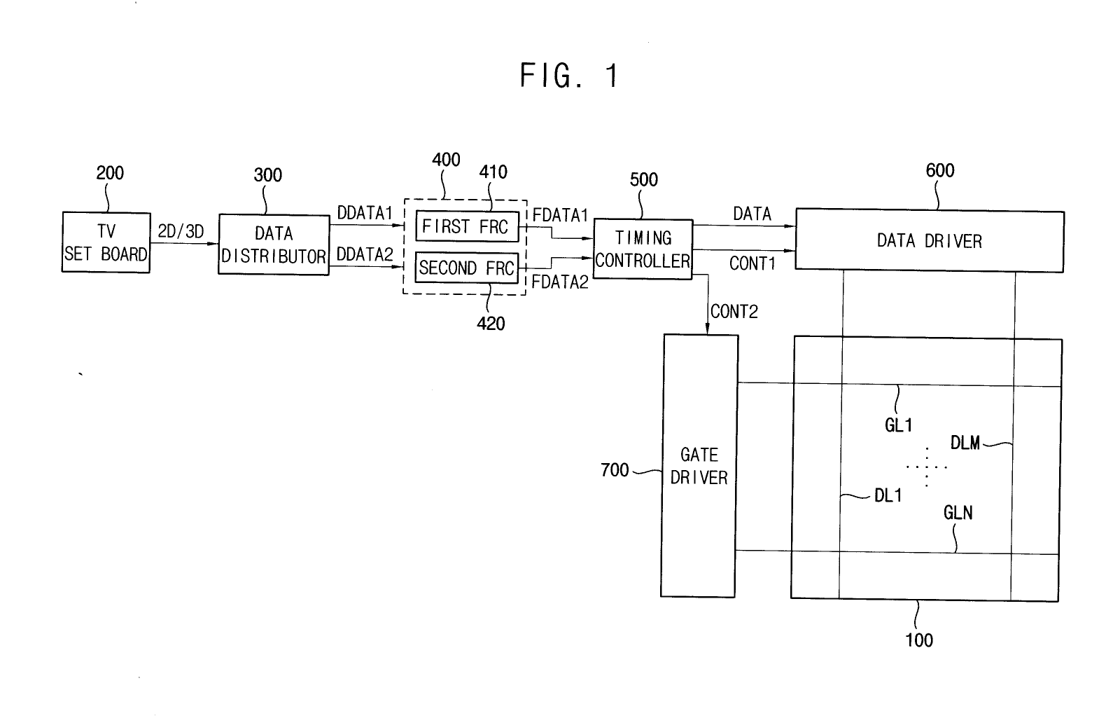

FIG. 1 is a block diagram illustrating an exemplary embodiment of a display apparatus according to the present invention.

Referring to FIG. 1, the display apparatus includes a display panel 100, a television (“TV”) set board 200, a data distributor 300, a frame rate converter (“FRC”) 400 and a display panel driver. The display panel driver includes a timing controller 500, data driver 600 and a gate driver 700.

The display panel 100 includes a plurality of gate lines GL1 to GLN, a plurality of data lines DL1 to DLM and a plurality of pixels connected to the gate lines GL1 to GLN and the data lines DL1 to DLM. Here, N and M are natural numbers. The gate lines GL1 to GLN extend in a first direction, and the data lines DL1 to DLM extend in a second direction crossing the first direction. The second direction may be substantially perpendicular to the first direction. Each pixel includes a switching element (not shown), a liquid crystal capacitor (not shown) and a storage capacitor (not shown).

The TV set board 200 receives input data from an external apparatus (not shown). The input data may be at least one of two-dimensional (“2D”) input data and three-dimensional (“3D”) input data. The TV set board 200 transmits the 2D and 3D input data to the data distributor 300.

In one exemplary embodiment, for example, when the input data is the 2D input data, a resolution of the 2D input data may be 1920×1080 pixels, which is a resolution of full high definition (“HD”) data. A frame rate of the 2D input data may be 60 hertz (Hz). In one exemplary embodiment, for example, when the input data is the 3D input data, the 3D input data includes left eye data and right eye data. In an exemplary embodiment, each of resolutions of the left eye data and the right eye data may be 1920×1080 pixels. In an exemplary embodiment, each of frame rates of the left eye data and the right eye data may be 60 Hz.

In one exemplary embodiment, for example, the 2D and 3D input data may be transmitted in a low voltage differential signaling (“LVDS”) method. In one exemplary embodiment, for example, the 2D and 3D input data may be transmitted by being divided into odd data corresponding to odd-numbered pixels and even data corresponding to even-numbered pixels.

The data distributor 300 receives the 2D and 3D input data from the TV set board 200. The data distributor 300 identifies a dimension of the input data, e.g., whether the input data is the 2D input data or the 3D input data. The data distributor 300 copies the input data, or redistributes the input data to generate first distributed data DDATA1 and second distributed data DDATA2 based on a dimension of the input data. The data distributor 300 outputs the first and second distributed data DDATA1 and DDATA2 to the FRC 400.

In one exemplary embodiment, for example, the 2D input data may be divided into the odd data and the even data, and inputted to the data distributor 300 through two channels. The left eye of the 3D input data may be inputted the data distributor 300 through two channels by being divided into the odd data and the even data, and the right eye data of the 3D input data may be inputted to the data distributor 300 through two channels by being divided into the odd data and the even data to. Accordingly, the 3D input data may be inputted to the data distributor 300 through four channels.

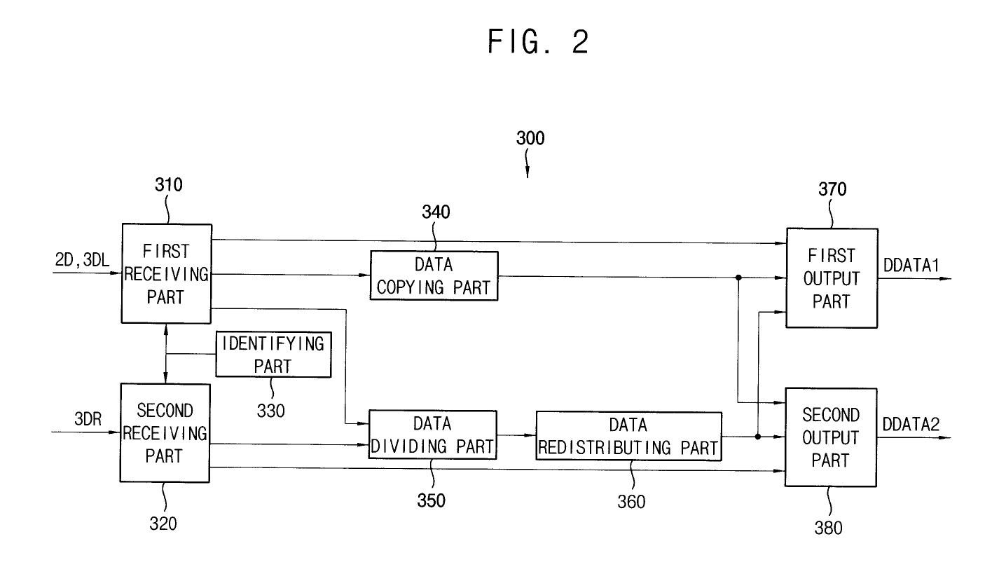

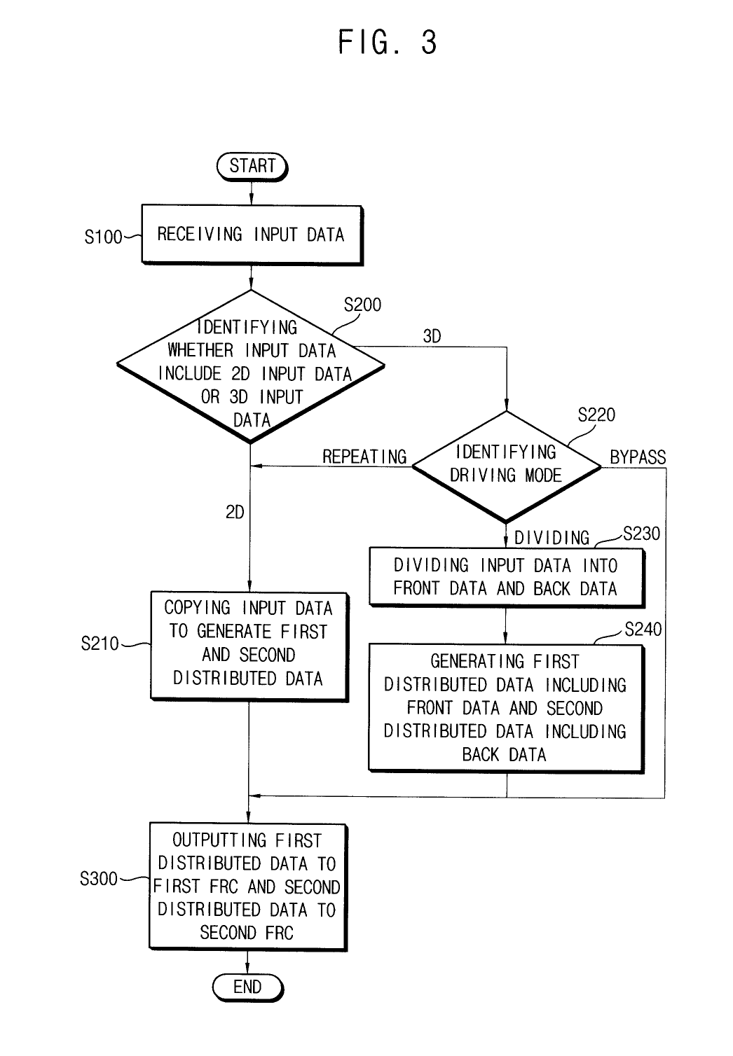

An operation of the data distributor 300 will be described later in detail referring to FIGS. 2 and 3.

The FRC 400 receives the first and second distributed data DDATA1 and DDATA2. The FRC 400 converts the frame rate of the first and second distributed data DDATA1 and DDATA2 based on the dimension of the input data.

In one exemplary embodiment, for example, when the input data is the 2D input data having a frame rate of 60 Hz, the FRC 400 converts the frame rates of the first and second distributed data DDATA1 and DDATA2 such that output data DATA may have a frame rate of 240 Hz. In one exemplary embodiment, for example, when the input data is the 3D input data including the left having frame rates of 60 Hz and right eye data having frame rates of 60 Hz, the FRC 400 converts the frame rates of the first and second distributed data DDATA1 and DDATA2 such that output data DATA may have a frame rate of 240 Hz.

The FRC 400 includes a first FRC 410 and a second FRC 420.

The first FRC 410 receives the first distributed data DDATA1 from the data distributor 300. The first FRC 410 converts the frame rate of the first distributed data DDATA1 to generate a first converted data FDATA1. The first FRC 410 outputs the first converted data FDATA1 to the timing controller 500.

The second FRC 420 receives the second distributed data DDATA2 from the data distributor 300. The second FRC 420 converts the frame rate of the second distributed data DDATA2 to generate a second converted data FDATA2. The second FRC 420 outputs the second converted data FDATA2 to the timing controller 500.

In one exemplary embodiment, for example, a resolution of the first converted data FDATA1 may be 960×1080 pixels. A frame rate of the first converted data FDATA1 may be 240 Hz. In addition, a resolution of the second converted data FDATA2 may be 960×1080 pixels. A frame rate of the second converted data FDATA2 may be 240 Hz. Converting capacity of each of the first and second FRCs may be a half of Full HD image, e.g., 1920×1080 pixels.

In such an embodiment, the FRC 400 includes a plurality of FRCs, e.g., the first FRC 410 and the second FRC 420, but not being limited thereto. In an alternative exemplary embodiment, the FRC may be a single FRC that receives both first and second converted data FDATA1 and FDATA2 and operates frame conversion.

The timing controller 500 receives the first and second converted data FDATA1 and FDATA2 from the frame rate converter 400. The timing controller 500 combines the first and second converted data FDATA1 and FDATA2 to generate the output data DATA corresponding to a grayscale. The timing controller 500 outputs the output data DATA to the data driver 600.

In one exemplary embodiment, for example, a resolution of the output data DATA may be 1920×1080 pixels. A frame rate of the output data DATA may be 240 Hz.

The timing controller 500 receives a control signal from outside. The control signal may include a master clock signal, a data enable signal, a vertical synchronizing signal and a horizontal synchronizing signal.

The timing controller 500 generates a first control signal CONT1 and a second control signal CONT2 based on the control signal. The timing controller 500 outputs the first control signal CONT1 to the data driver 600. The timing controller 500 outputs the second control signal CONT2 to the gate driver 700.

The first control signal CONT1 may include a horizontal start signal, a load signal, an inverting signal and a data clock signal. The second control signal CONT2 may include a vertical start signal, a gate clock signal, a gate on signal and so on.

The data driver 600 receives the output data DATA and the first control signal CONT1 from the timing controller 500. The data driver 600 converts the output data DATA to a data voltage having an analogue type to output the data voltage to the data lines DL1 to DLM.

A gamma voltage generator (not shown) generates a gamma reference voltage to provide the gamma reference voltage to the data driver 600. The gamma voltage generator may be disposed in the data driver 600 or in the timing controller 500.

The data driver 600 may include a shift register (not shown), a latch (not shown), a signal processor (not shown) and a buffer (not shown). The shift register outputs a latch pulse to the latch. The latch temporarily stores the output data DATA, and outputs the output data DATA. The signal processor converts the output data having a digital type into the data voltage having an analogue type to output the data voltage. The buffer compensates the data voltage outputted from the signal processor to have a uniform level, and outputs the data voltage.

In an exemplary embodiment, the data driver 600 may be disposed, e.g., directly mounted, on the display panel 100, or be connected to the display panel 100 in a tape carrier package (“TCP”) type. In an alternative exemplary embodiment, the data driver 600 may be integrated on the display panel 100.

The gate driver 700 generates gate signals to drive the gate lines GL1 to GLN in response to the first control signal CONT1 received from the timing controller 500. The gate driver 700 sequentially outputs the gate signals to the gate lines GL1 to GLN.

In an exemplary embodiment, the gate driver 700 may be disposed, e.g., directly mounted, on the display panel 100, or be connected to the display panel 100 in a TCP type. In an alternative exemplary embodiment, the gate driver 700 may be integrated on the display panel 100.

FIG. 2 is a block diagram illustrating an exemplary embodiment of the data distributor 300 of FIG. 1. FIG. 3 is a flowchart illustrating an exemplary embodiment of a method of processing the input data by the data distributor 300 of FIG. 1.

Referring to FIGS. 2 and 3, the data distributor 300 includes a first receiving part 310, a second receiving part 320, an identifying part 330, a data copying part 340, a data dividing part 350, a data redistributing part 360, a first output part 370 and a second output part 380.

The first and second receiving parts 310 and 320 receive the input data (step S100).

The first receiving part 310 receives the 2D input data and the left eye data 3DL of the 3D input data. When the 2D input data and the left eye data 3DL are divided into the odd and even data, the first receiving part 310 may include a first channel that receives the odd data and a second channel that receives the even data.

The second receiving part 320 receives the right eye data 3DR of the 3D input data. When the right eye data 3DR are divided into the odd and even data, the second receiving part 320 may include a first channel that receives the odd data and a second channel that receives the even data.

In such an embodiment, the 2D input data is received from the first receiving part 310. In an alternative exemplary embodiment, however, the 2D input data may be received from the second receiving part 320.

The identifying part 330 identifies a dimension of the input data, which includes at least one of the 2D input data and the 3D input data, e.g., the identifying part 330 identifies whether the input data is the 2D input data or the 3D input data (step S200). In an exemplary embodiment, the identifying part 330 may identify a dimension of the input data based on a 3D enable signal from outside. In an alternative exemplary embodiment, the identifying part 330 may identify the dimension of the input data based on the input data.

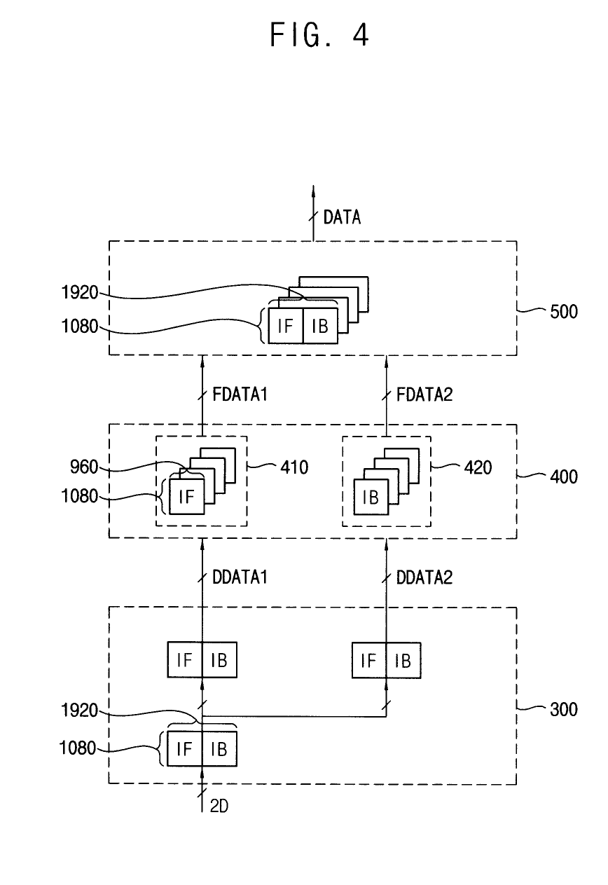

When the input data is the 2D input data, the 2D input data is transmitted to the data copying part 340. The data copying part 340 copies the 2D input data to generate the first distributed data DDATA1 and the second distributed data DDATA2 (step S210). A method of processing the 2D input data will be described later in detail referring to FIG. 4.

When the input data is the 3D input data, the 3D input data is processed based on a driving mode. The identifying part 330 identifies the driving mode (step S220). In an exemplary embodiment, the identifying part 330 may receive a driving mode signal from outside to identify the driving mode. In an alternative exemplary embodiment, the identifying part 330 may identify the driving mode based on the input data. The driving mode may include a first mode, a second mode and a third mode.

In an exemplary embodiment, the first mode is a dividing mode. The dividing mode is a mode for processing normal 3D input data. In the dividing mode, the normal 3D input data include the left eye data 3DL and the right eye data 3DR.

In the dividing mode, the left eye data 3DL and the right eye data 3DR are transmitted to the data dividing part 350. The data dividing part 350 divides the left eye data 3DL into front data and back data, and divides the right eye data 3DR into front data and back data (step S230). Herein, the front data corresponds to an image displayed on a left side of the display panel 100, and the back data corresponds to an image displayed on a right side of the display panel 100.

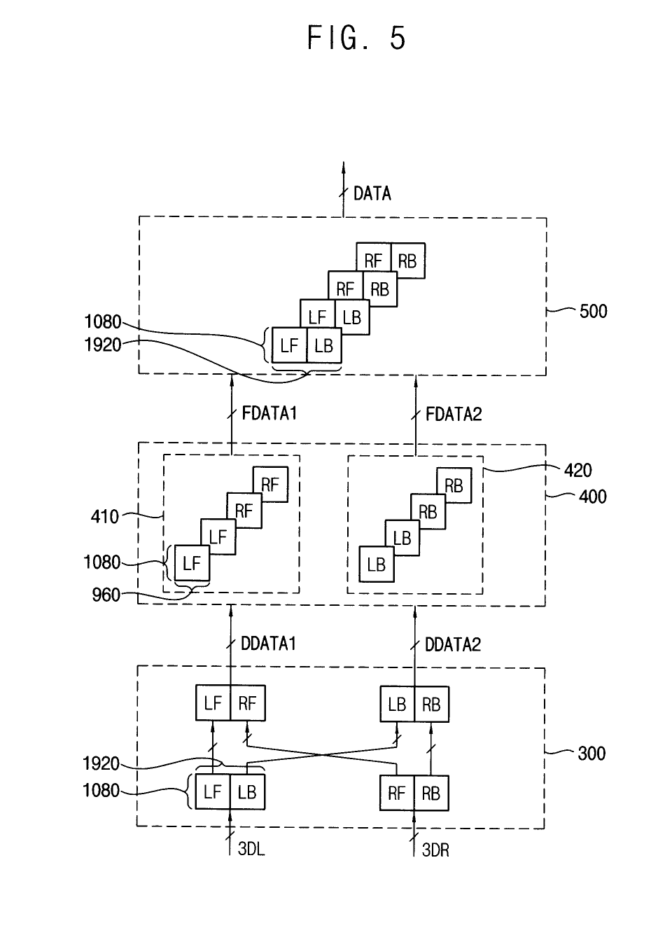

The data redistributing part 360 generates the first distributed data DDATA1 including the front data of the left eye data 3DL and the front data of the right eye data 3DR and the second distributed data DDATA2 including the back data of the left eye data 3DL and the back data of the right eye data 3DR (step S240). An exemplary embodiment of a method of processing the 3D input data in the dividing mode will be described later in detail referring to FIG. 5.

In an exemplary embodiment, the second mode is a repeating mode. The repeating mode is a mode for processing abnormal 3D input data. In the repeating mode, the abnormal 3D input data include only the left eye data 3DL. Even though the dimension of the input data is identified as the 3D, the 3D input data include only the left eye data 3DL. When the abnormal 3D input data are processed in the dividing mode, the display panel 100 displays an abnormal image.

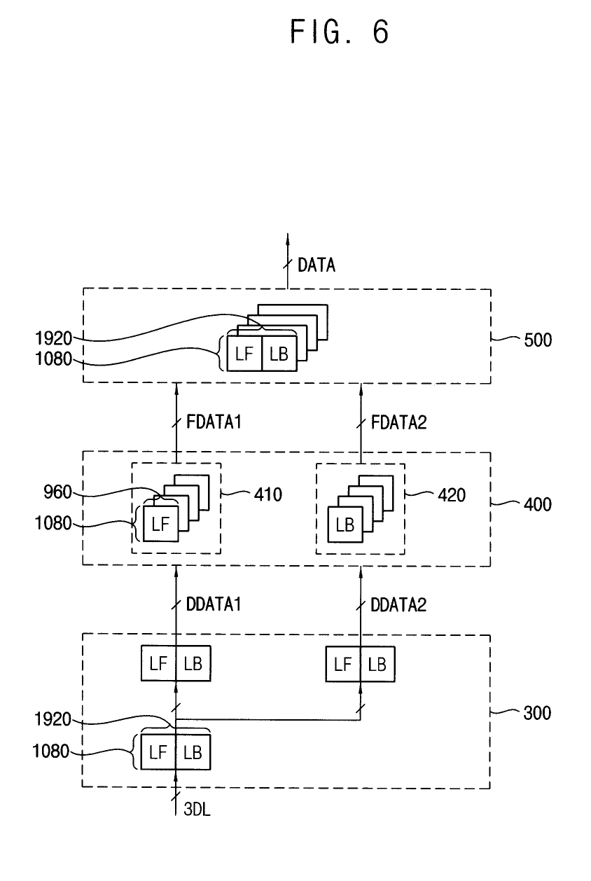

Therefore, the input data in the repeating mode are regarded as the 2D input data, and are processed same as the 2D input data. The left eye data 3DL is transmitted to the data copying part 340. The data copying part 340 copies the left eye data 3DL to generate the first distributed data DDATA1 and the second distributed data DDATA2 (step S210). An exemplary embodiment of a method of processing the 3D input data in the repeating mode will be described later in detail referring to FIG. 6.

In an exemplary embodiment, the abnormal 3D input data including only the left eye data 3DL received from the first receiving part 310. In an alternative exemplary embodiment, the abnormal 3D input data may include only the right eye data 3DR received from the second receiving part 320.

In an exemplary embodiment, the third mode is a bypass mode. The bypass mode is a mode for testing operation of the data distributor 300. In the bypass mode, the 3D input data include the left eye data 3DL and the right eye data 3DR.

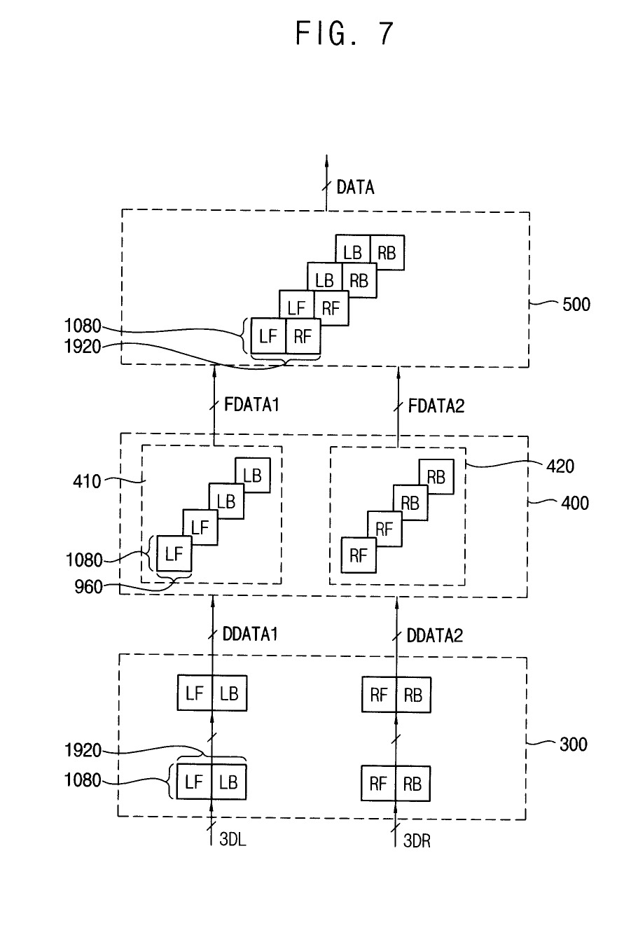

In the bypass mode, the left eye data 3DL and the right eye data 3DR are directly transmitted to the first and second output part 370 and 380. The left eye data 3DL is transmitted to the first output part 370. The right eye data 3DR is transmitted to the second output part 380. Accordingly, the first distributed data DDATA1 include the left eye data 3DL, and the second distributed data DDATA2 include the right eye data 3DR. An exemplary embodiment of a method of processing the 3D input data in the bypass mode will be described later in detail referring to FIG. 7.

The first and second output part 370 and 380 outputs the first and second distributed data DDATA1 and DDATA2, respectively, to the FRC 400 (step S300).

The first output part 370 outputs the first distributed data DDATA1 to the first FRC 410. The first distributed data DDATA1 may be divided into the odd data and the even data. The first output part 370 may include a first channel that outputs the odd data and a second channel that outputs the even data.

The second output part 380 outputs the second distributed data DDATA2 to the second FRC 420. The second distributed data DDATA2 may be divided into the odd data and the even data. The second output part 380 may include a first channel that outputs the odd data and a second channel that outputs the even data.

FIG. 4 is a block diagram illustrating an exemplary embodiment of a method of processing 2D input data by the data distributor 300, a FRC 400 and a timing controller 500 of FIG. 1.

Referring to FIGS. 1 to 4, the first receiving part 310 of the data distributor 300 receives the 2D input data. The identifying part 330 receives the 3D enable signal from an outside. The identifying part 330 identifies the input data as the 2D input data based on the 3D enable signal from the outside. The second receiving part 320 which does not receive the 2D input data may be shut down such that power dissipation of the display apparatus substantially decreases.

In such an embodiment, the first receiving part 310 receives the 2D input data. In an alternative exemplary embodiment, the second receiving part 320 may receive the 2D input data, and the first receiving part 310 does not receive the 2D part. When, the first receiving part 310 does not receive the 2D input data, the first receiving part 310 may be shut down.

A resolution of the 2D input data may be 1920×1080 pixels. A frame rate of the 2D input data may be 60 Hz. The 2D input data include front data IF and back data IB. Resolution of each of the front and back data IF and IB may be 960×1080 pixels. Frame rate of each of the front and back data IF and IB may be 60 Hz.

The 2D input data including the front data IF and the back data 1B are transmitted to the data copying part 340. The data copying part 340 copies the 2D input data including the front data IF and the back data 1B to generate the first and second distributed data DDATA1 and DDATA2. In an exemplary embodiment, resolution of each of the first and second distributed data DDATA1 and DDATA2 may be 1920×1080 pixels. Frame rate of each of the first distributed data DDATA1 and the second distributed data DDATA2 may be 60 Hz.

The first distributed data DDATA1 include the front data IF and the back data IB, and the second distributed data DDATA2 include the front data IF and the back data IB. In this step, the front data IF and the back data IB are not divided.

The first output part 370 outputs the first distributed data DDATA1 to the first FRC 410, and the second output part 380 outputs the second distributed data DDATA2 to the second FRC 420.

The first FRC 410 converts the frame rate of the first distributed data DDATA1 to generate the first converted data FDATA1. The first FRC 410 extracts the front data IF of the first distributed data DDATA1. The first FRC 410 copies the front data IF to generate four front data IF. Therefore, the first converted data FDATA1 include only the front data IF. A resolution of the first converted data FDATA1 may be 960×1080 pixels. A frame rate of the first converted data FDATA1 may be 240 Hz. The first FRC 410 outputs the first converted data FDATA1 to the timing controller 500.

The second FRC 420 converts the frame rate of the second distributed data DDATA2 to generate the second converted data FDATA2. The second FRC 420 extracts the back data IB of the second distributed data DDATA2. The second FRC 420 copies the back data IB to generate four back data IB. Therefore, the second converted data FDATA2 include only the back data IB. A resolution of the second converted data FDATA2 may be 960×1080 pixels. A frame rate of the second converted data FDATA2 may be 240 Hz. The second FRC 420 outputs the second converted data FDATA2 to the timing controller 500.

In such an embodiment, the first converted data FDATA1 includes only the front data IF, and the second converted data FDATA2 includes only the back data IB. In an alternative exemplary embodiment, however, each of the first and second converted data FDATA1 and FDATA2 may include both the front data IF and the back data IB.

The timing controller 500 receives the first and second converted data FDATA1 and FDATA2 from the first and second FRCs 410 and 420, respectively. The timing controller 500 combines the first and second converted data FDATA1 and FDATA2 to generate the output data DATA corresponding to a grayscale. The output data DATA include four front data IF and four back data IB combined with each other. A resolution of the output data DATA may be 1920×1080 pixels. A frame rate of the output data DATA may be 240 Hz.

FIG. 5 is a block diagram illustrating an exemplary embodiment of the method of processing 3D input data in the first mode by the data distributor 300, the FRC 400 and the timing controller 500 of FIG. 1.

Referring to FIGS. 1 to 3 and 5, the first receiving part 310 of the data distributor 300 receives the left eye data 3DL. The second receiving part 320 of the data distributor 300 receives the right eye data 3DR. The identifying part 330 identifies the input data as the 3D input data based on the 3D enable signal from the outside, and identifies the driving mode as the dividing mode. The identifying part 330 may identify the driving mode as the dividing mode based on the input data. The identifying part 330 may identify the driving mode as the dividing mode based on the driving mode signal.

Resolution of each of the left eye data 3DL and the right eye data 3DR may be 1920×1080 pixels. Frame rate of each of the left eye data 3DL and the right eye data 3DR may be 60 Hz. The left eye data 3DL includes a front data LF and a back data LB, and the right eye data 3DR includes a front data RF and a back data RB. Resolution of the front data LF and RF may be 960×1080 pixels. Resolution of the back data LB and RB may be 960×1080 pixels. Frame rates of the front data LF and RF may be 60 Hz. Frame rate of each of the back data LB and RB may be 60 Hz.

The left eye data LF and LB and the right eye data RF and RB are transmitted to the data dividing part 350. The data dividing part 350 divides the left eye data LF and LB into the front data LF and the back data LB, and divides the right eye data RF and RB into the front data RF and the back data RB.

The data redistributing part 360 exchanges the back data LB of the left eye data 3DL with the front data RF of the right eye data 3DR to generate the first and second distributed data DDATA1 and DDATA2. The first distributed data DDATA1 include the front data LF of the left eye data 3DL and the front data RF of the right eye data 3DR, and the second distributed data DDATA2 include the back data LB of the left eye data 3DL and the back data RB of the right eye data 3DR. In this step, the front and back data LF and LB of the left eye data 3DL and the front and back data RF and RB of the right eye data 3DR are divided and redistributed. Herein, resolution of each of the first and second distributed data DDATA1 and DDATA2 may be 1920×1080 pixels. Frame rate of each of the first and second distributed data DDATA1 and DDATA2 may be 60 Hz.

The first FRC 410 extracts the front data LF of the left eye data 3DL of the first distributed data DDATA1. The first FRC 410 copies the front data LF of the left eye data 3DL to generate two front data LF. The first FRC 410 extracts the front data RF of the right eye data 3DR of the first distributed data DDATA1. The first FRC 410 copies the front data RF of the right eye data 3DR to generate two front data RF.

Therefore, the first converted data FDATA1 includes the doubled front data LF of the left eye data 3DL and the doubled front data RF of the right eye data 3DR. A resolution of the first converted data FDATA1 may be 960×1080 pixels. A frame rate of the first converted data FDATA1 may be 240 Hz.

The second FRC 420 extracts the back data LB of the left eye data 3DL of the second distributed data DDATA2. The second FRC 420 copies the back data LB of the left eye data 3DL to generate two back data LB. The second FRC 420 extracts the back data RB of the right eye data 3DR of the second distributed data DDATA2. The second FRC 420 copies the back data RB of the right eye data 3DR to generate two back data RB.

Therefore, the second converted data FDATA2 includes the doubled back data LB of the left eye data 3DL and the doubled back data RB of the right eye data 3DR. A resolution of the second converted data FDATA2 may be 960×1080 pixels. A frame rate of the second converted data FDATA2 may be 240 Hz.

The timing controller 500 combines the first and second converted data FDATA1 and FDATA2 to generate the output data DATA corresponding to a grayscale. The output data DATA include left output data generated based on the left eye data LF and LB, right output data generated based on the RF and RB. The output data DATA include two front data LF and two back data LB of the left eye data 3DL combined with each other, and two front data RF and two back data RB of the right eye data 3DR combined with each other. A resolution of the output data DATA may be 1920×1080 pixels. A frame rate of the output data DATA may be 240 Hz.

The left output data, the left output data, the right output data and the right output data may be sequentially disposed in the output data DATA.

The left output data, black data, the right output data and the black data may be sequentially disposed in the output data DATA. When the black data are disposed between the left output data and the right output data, image sticking may be prevented so that display quality may be improved. The timing controller 500 may convert the left output data and the right output data into the black data.

FIG. 6 is a block diagram illustrating an exemplary embodiment of the method of processing 3D input data in the second mode by the data distributor 300, the FRC 400 and the timing controller 500 of FIG. 1.

Referring to FIGS. 1 to 3 and 6, the first receiving part 310 of the data distributor 300 receives the left eye data 3DL. The identifying part 330 receives the 3D enable signal from outside. The identifying part 330 identifies the input data as the 3D input data based on the 3D enable signal from outside. The identifying part 330 identifies the driving mode as the repeating mode. The identifying part 330 may identify the driving mode as the repeating mode based on the input data. The identifying part 330 may identify the driving mode as the repeating mode based on the driving mode signal. The second receiving part 320 which does not receive the left eye data 3DL may be shut down such that power dissipation of the display apparatus substantially decreases.

In such an embodiment, the first receiving part 310 receives the left eye data 3DL. In an alternative exemplary embodiment, the second receiving part 320 may receive the left eye data 3DL. When the first receiving part 310 does not receive the left eye data 3DL, the first receiving part 310 may be shut down.

A resolution of the left eye data 3DL may be 1920×1080 pixels. A frame rate of the left eye data 3DL may be 60 Hz. The left eye data 3DL include the front data LF and the back data LB. Resolution of each of the front and back data LF and LB may be 960×1080 pixels. Frame rate of each of the front and back data LF and LB may be 60 Hz.

The left eye data LF and LB are transmitted to the data copying part 340. The data copying part 340 copies the left eye data LF and LB to generate the first and second distributed data DDATA1 and DDATA2. In such an embodiment, resolution of each of the first and second distributed data DDATA1 and DDATA2 is 1920×1080 pixels. Frame rate of each of the first and second distributed data DDATA1 and DDATA2 may be 60 Hz.

The first distributed data DDATA1 include the front data LF and the back data LB, and the second distributed data DDATA2 include the front data LF and the back data LB. In this step, the front data LF and the back data LB are not divided.

The first FRC 410 converts the frame rate of the first distributed data DDATA1 to generate the first converted data FDATA1. The first FRC 410 extracts the front data LF of the first distributed data DDATA1. The first FRC 410 copies the front data LF to generate four front data LF. Therefore, the first converted data FDATA1 include the front data LF only. A resolution of the first converted data FDATA1 may be 960×1080 pixels. A frame rate of the first converted data FDATA1 may be 240 Hz.

The second FRC 420 converts the frame rate of the second distributed data DDATA2 to generate the second converted data FDATA2. The second FRC 420 extracts the back data LB of the second distributed data DDATA2. The second FRC 420 copies the back data LB to generate four back data LB. Therefore, the second converted data FDATA2 include the back data LB only. A resolution of the second converted data FDATA2 may be 960×1080 pixels. A frame rate of the second converted data FDATA2 may be 240 Hz.

In such an embodiment, the first converted data FDATA1 include only the front data LF and the second converted data FDATA2 include only the back data LB. In an alternative exemplary embodiment, however, each of the first and second converted data FDATA1 and FDATA2 may include both the front data LF and the back data LB.

The timing controller 500 combines the first and second converted data FDATA1 and FDATA2 to generate the output data DATA corresponding to a grayscale. The output data DATA include four front data LF and four back data LB combined with each other. A resolution of the output data DATA may be 1920×1080 pixels. A frame rate of the output data DATA may be 240 Hz.

FIG. 7 is a block diagram illustrating an exemplary embodiment of the method of processing 3D input data in the third mode by the data distributor 300, the FRC 400 and the timing controller 500 of FIG. 1.

Referring to FIGS. 1 to 3 and 7, the first receiving part 310 of the data distributor 300 receives the left eye data 3DL. The second receiving part 320 of the data distributor 300 receives the right eye data 3DR. The identifying part 330 identifies the input data as the 3D input data based on the 3D enable signal from an outside. The identifying part 330 identifies the driving mode as the bypass mode. The identifying part 330 may identify the driving mode as the bypass mode based on the input data. The identifying part 330 may identify the driving mode as the bypass mode based on the driving mode signal.

Resolution of each of the left eye data 3DL and the right eye data 3DR may be 1920×1080 pixels. Frame rate of each of the left eye data 3DL and the right eye data 3DR may be 60 Hz. The left eye data 3DL includes the front data LF and the back data LB, and the right eye data 3DR includes the front data RF and the back data RB. Resolution of each of the front data LF and RF may be 960×1080 pixels. Resolution of each of the back data LB of the left eye data 3DL and the back data RB of the right eye data 3DR may be 960×1080 pixels. Frame rate of each of the front data LF of the left eye data 3DL and the front data RF of the right eye data 3DR may be 60 Hz. Frame rate of each of the back data LB of the left eye data 3DL and the back data RB of the right eye data 3DR may be 60 Hz.

The front data LF and the back data LB of the left eye data 3DL are transmitted to the first output part 370. The front data RF and the back data RB of the right eye data 3DR are transmitted to the second output part 380. The first distributed data DDATA1 include the front data LF and the back data LB of the left eye data 3DL, and the second distributed data DDATA2 include the front data RF and the back data RB of the right eye data 3DR. In this step, the front data LF, RF and the back data LB, RB are not divided. In such an embodiment, resolution of each of the first and second distributed data DDATA1 and DDATA2 may be 1920×1080 pixels. Frame rate of each of the first and second distributed data DDATA1 and DDATA2 may be 60 Hz.

The first FRC 410 extracts the front data LF of the left eye data 3DL from the first distributed data DDATA1. The first FRC 410 copies the front data LF of the left eye data 3DL to generate two front data LF. The first FRC 410 extracts the back data LB of the left eye data 3DL from the first distributed data DDATA1. The first FRC 410 copies the back data LB of the left eye data 3DL to generate two back data LB.

Therefore, the first converted data FDATA1 includes the doubled front data LF of the left eye data 3DL and the doubled back data LB of the left eye data 3DL. A resolution of the first converted data FDATA1 may be 960×1080 pixels. A frame rate of the first converted data FDATA1 may be 240 Hz.

The second FRC 420 extracts the front data RF of the right eye data 3DR from the second distributed data DDATA2. The second FRC 420 copies the front data RF of the right eye data 3DR to generate two back data RF. The second FRC 420 extracts the back data RB of the right eye data 3DR from the second distributed data DDATA2. The second FRC 420 copies the back data RB of the right eye data 3DR to generate two back data RB.

Therefore, the second converted data FDATA2 includes the doubled front data RF of the right eye data 3DR and the doubled back data RB of the right eye data 3DR. A resolution of the second converted data FDATA2 may be 960×1080 pixels. A frame rate of the second converted data FDATA2 may be 240 Hz.

The timing controller 500 combines the first and second converted data FDATA1 and FDATA2 to generate the output data DATA corresponding to a grayscale. The output data DATA include two front data LF of the left eye data 3DL and two front data RF of the right eye data 3DR combined with each other, and two back data LB of the left eye data 3DL and two back data RB of the right eye data 3DR combined with each other. A resolution of the output data DATA may be 1920×1080 pixels. A frame rate of the output data DATA may be 240 Hz.

Since the bypass mode is for testing operation of the data distributor 300, a method of processing the data of the FRC 400 and the timing controller 500 is not limited to the exemplary embodiment illustrated in FIG. 7.

In an exemplary embodiment, the data distributor 300 is disposed before the FRC 400 and the timing controller 500 such that a conventional repeater and 3D converter may be omitted.

In an exemplary embodiment, the data distributor 300, the FRC 400 and the timing controller 500 process data based on the dimension of the input data such that the 2D input data and the 3D input data may be processed through the same path, and the wirings may be simplified.

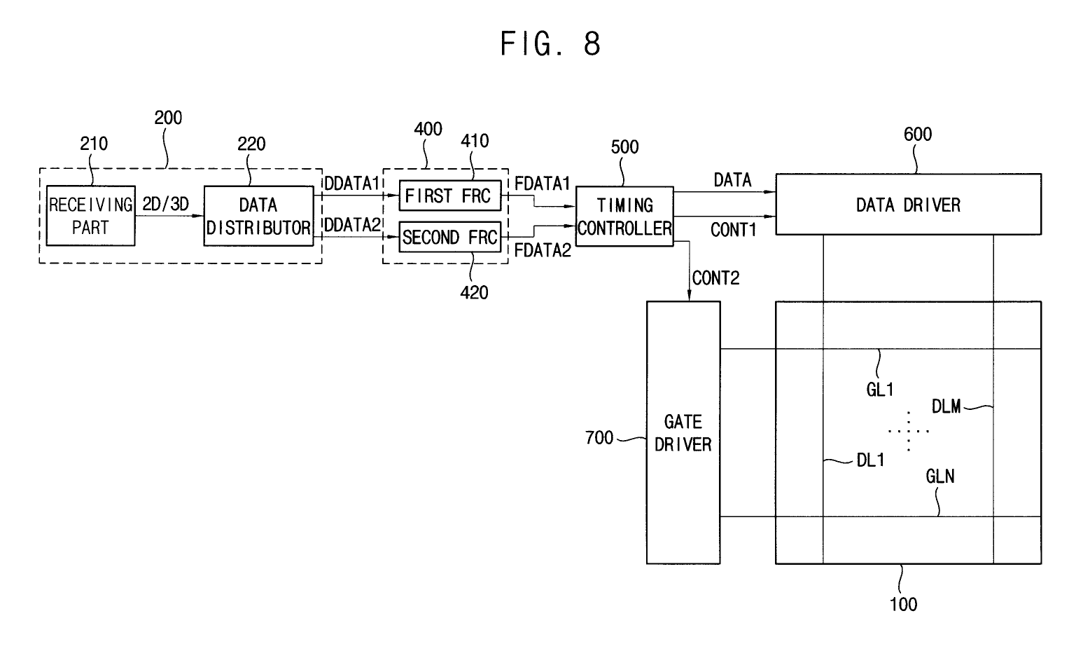

FIG. 8 is a block diagram illustrating an alternative exemplary embodiment of the display apparatus according to the present invention.

The display apparatus in FIG. 8 is substantially the same as the display apparatus illustrated in FIG. 1 except for a position of the data distributor 220. In addition, a method of processing the input data of the data distributor 220 in FIG. 8 is substantially the same as the method of processing the input data of the data distributor 300 illustrated in FIG. 3. Thus, the same or like elements shown in FIG. 8 have been labeled with the same reference characters as used above to describe the exemplary embodiment in FIGS. 1 to 7, and any repetitive detailed description thereof will hereinafter be omitted or simplified.

Referring to FIG. 8, the display apparatus includes a display panel 100, a TV set board 200, an FRC 400 and a display panel driver. The display panel driver includes a timing controller 500, a data driver 600 and a gate driver 700.

The TV set board 200 includes a receiving part 210 and the data distributor 220. The receiving part 210 receives input data from an external apparatus (not shown). The input data may be 2D input data and 3D input data. The receiving part 210 transmits the 2D and 3D input data to the data distributor 220.

The data distributor 220 may be disposed, e.g., mounted, on the TV set board 200. The data distributor 220 may be integrated into a TV set such that the data distributor 220 may be integrally formed with the TV set in a chip type.

The FRC 400 includes a first FRC 410 and a second FRC 420.

In such an embodiment, the data distributor 220 is disposed, e.g., mounted, on the TV set board 200, or integrated into the TV set chip such that the structures of the display apparatus and the wirings may be further simplified.

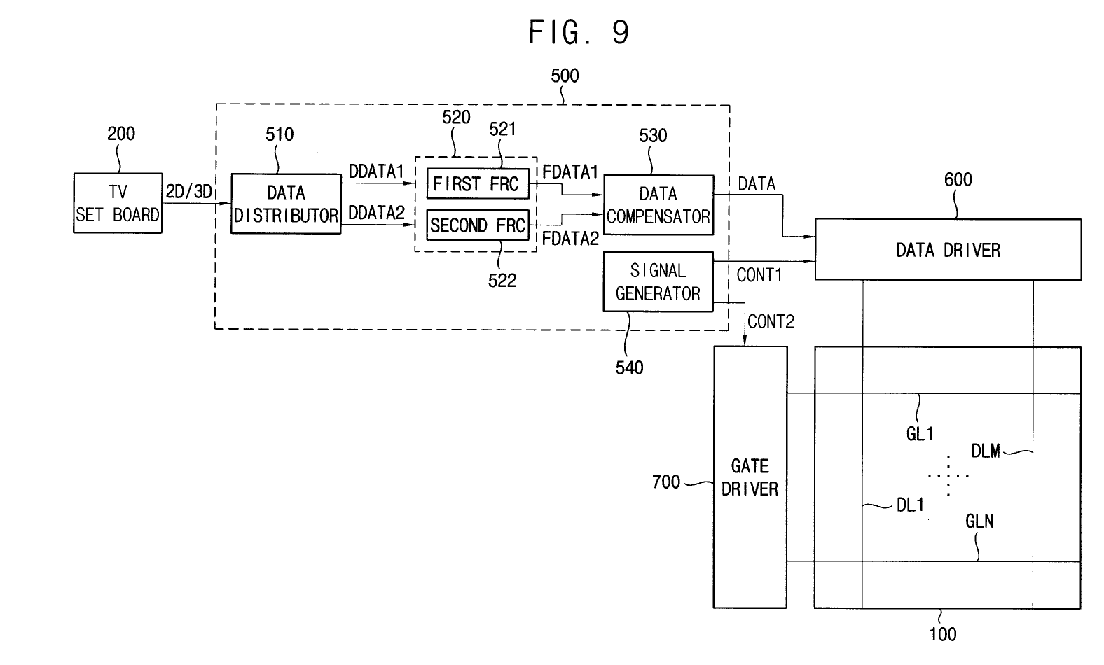

FIG. 9 is a block diagram illustrating an alternative exemplary embodiment of the display apparatus according to the present invention.

The display apparatus in FIG. 9 is substantially the same as the display apparatus illustrated in FIG. 1 except for a position of the data distributor 510. In addition, a method of processing the input data of the data distributor 510 in FIG. 9 is substantially the same as the method of processing the input data of the data distributor 300 illustrated in FIG. 3. Thus, the same or like elements shown in FIG. 9 have been labeled with the same reference characters as used above to describe the exemplary embodiment in FIGS. 1 to 7, and any repetitive detailed description thereof will hereinafter be omitted or simplified.

Referring to FIG. 9, the display apparatus includes a display panel 100, a TV set board 200 and a display panel driver. The display panel driver includes a timing controller 500, a data driver 600 and a gate driver 700.

The timing controller 500 includes the data distributor 510, a FRC 520, a data compensator 530 and a signal generator 540. The data compensator 530 combines first and second converted data FDATA1 and FDATA2 received from the FRC 520 to generate output data DATA corresponding to a grayscale. The signal generator 540 generates a first control signal CONT1 and a second control signal CONT2 based on a control signal received from outside.

The FRC 520 includes a first FRC 521 and a second FRC 522.

The data distributor 510, the first FRC 521, the second FRC 522, the data compensator 530 and the signal generator 540 may be disposed, e.g., mounted, on a timing controller substrate. The data distributor 510, the first FRC 521, the second FRC 522, the data compensator 530 and the signal generator 540 may be integrally formed as a timing controller chip.

In such an embodiment, the data distributor 510 is disposed, e.g., mounted, on the timing controller board, or integrated into the timing controller chip such that the structures of the display apparatus and the wirings may be further simplified.

In such an embodiment, the data distributor is disposed before the FRC and the timing controller such that the structures of the display apparatus may be simplified.

In addition, the data distributor, the FRC and the timing controller process data according to the dimension of the input data such that the 2D input data and the 3D input data may be processed through the same path, and the wirings is thereby substantially simplified.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A method of driving a display panel, the method comprising:
identifying a dimension of input data, wherein the input data is one of two-dimensional input data and three-dimensional input data; and
generating first distributed data and second distributed data based on the dimension of the input data by at least one of copying the input data and dividing the input data into front data and back data.

2. The method of claim 1, further comprising:
outputting the first distributed data to a first frame rate converter; and
outputting the second distributed data to a second frame rate converter.

3. The method of claim 1, wherein
when the input data is the three-dimensional input data and when the three-dimensional input data includes left eye data and right eye data, the first distributed data includes front data of the left eye data and front data of the right eye data and the second distributed data includes back data of the left eye data and back data of the right eye data.

4. The method of claim 3, wherein a resolution of each of the left eye data and the right eye data is 1920×1080 pixels.

5. The method of claim 3, wherein a frame rate of each of the left eye data and the right eye data is 60 hertz.

6. The method of claim 5, further comprising:
outputting output data to the display panel,
wherein the output data includes left output data generated based on the left eye data and right output data generated based on the right eye data, and
wherein a frame rate of the output data is 240 hertz.

7. The method of claim 6, wherein the output data includes the left output data, black data, the right output data and the black data sequentially disposed therein.

8. The method of claim 6, wherein the output data includes the left output data, the left output data, the right output data and the right output data sequentially disposed therein.

9. The method of claim 1, wherein when the input data is the three-dimensional input data and when the three-dimensional input data includes one of the left eye data and the right eye data, the first distributed data and the second distributed data are generated by copying the input data.

10. The method of claim 9, further comprising:
receiving the input data into receiving parts; and
shutting down a portion of the receiving parts which do not receive the input data.

11. The method of claim 1, wherein
when the input data is the three-dimensional input data and when the input data includes the left eye data and the right eye data, the first distributed data includes left eye data and the second distributed data includes right eye data.

12. The method of claim 1, wherein the first distributed data and the second distributed data are generated by copying the input data when the input data includes the two-dimensional input data.

13. The method of claim 12, further comprising:
receiving the input data into receiving parts; and
shutting down a portion of the receiving parts which do not receive the input data.

14. A display apparatus comprising:
a display panel which displays an image;
a data distributor which identifies a dimension of input data, and generates first distributed data and second distributed data based on the dimension of the input data by at least one of copying the input data and dividing the input data into front data and back data, wherein the input data is one of two-dimensional input data and three-dimensional input data; and
a display panel driver which outputs a data voltage to the display panel using the first distributed data and the second distributed data.

15. The display apparatus of claim 14, further comprising:
a frame rate converter comprising:
a first frame rate converter which converts a frame rate of the first distributed data; and
a second frame rate converter which converts a frame rate of the second distributed data.

16. The display apparatus of claim 14, wherein when the input data is the three-dimensional input data and when the three-dimensional input data includes left eye data and right eye data, the first distributed data includes front data of the left eye data and front data of the right eye data, and the second distributed data includes back data of the left eye data and back data of the right eye data.

17. The display apparatus of claim 14, wherein the data distributor is disposed on a television set board which receives the input data from an external apparatus.

18. The display apparatus of claim 14, wherein the data distributor is integrated into a television set chip which receives the input data from an external apparatus.

19. The display apparatus of claim 14, wherein the data distributor is disposed on a timing controller substrate of the display panel driver, wherein the timing controller generates a control signal and grayscale data.

20. The display apparatus of claim 14, wherein the data distributor is integrated into a timing controller chip of the display panel driver, wherein the timing controller generates a control signal and grayscale data.
